(19) United States
(12) Patent Application Publication
(10) Pub. No.: US 2017/0124583 A1
(43) Pub. Date: May 4, 2017

(54) PART MACHINING COST ESTIMATING SYSTEM, PART MACHINING COST ESTIMATING METHOD, PART MACHINING COST ESTIMATING APPARATUS, AND PART MACHINING COST ESTIMATING PROGRAM

(71) Applicant: ENPLAS CORPORATION, Saitama (JP)

(72) Inventors: Katsutoshi TAKIZAWA, Saitama (JP); Mamoru TAKEUCHI, Saitama (JP)

(21) Appl. No.: 15/333,510

(22) Filed: Oct. 25, 2016

(30) Foreign Application Priority Data
Oct. 29, 2015 (JP) 2015-212558

(51) Int. Cl. G06Q 30/02

(52) U.S. Cl. CPC G06Q 30/0206; G06Q 30/0283

(57) ABSTRACT

A part machining cost estimating server includes: an inputted estimate data accepting unit that accepts inputted estimate data; a determination unit that determines whether the inputted estimate data satisfies predetermined estimate conditions or not; an estimate reference price memory unit in which estimate reference prices derived in accordance with first predicted data of the inputted estimate data in advance based on experiences are stored in association with the first predicted data of the inputted estimate data; an estimate coefficient memory unit that derives coefficients in accordance with second predicted data of the inputted estimate data in advance based on experiences are stored in association with the second predicted data of the inputted estimate data; an estimated sum calculating unit that calculates an estimated sum by multiplying the estimate reference price by the coefficient; and an estimate number assigning unit that assigns an estimate number to the estimated sum.

### BACKGROUND OF THE INVENTION

1. Field of the Invention

The present invention relates to a part machining cost estimating system, a part machining cost estimating method, a part machining cost estimating apparatus, and a part machining cost estimating program.

2. Description of the Related Art

For example, in a case where enterprises that do not have production equipment in their own companies or workers in university laboratories or the like have completed an engineering drawing of a part (a prototype or mass-produced product such as a resin gear and a metallic gear) and need to manufacture the designed part based on the engineering drawing, they request an estimate for part machining cost from an external part manufacturer before placing a formal order, and then determine whether to order or not based on a result of the estimate.

### First Example of the Related Art

One of known systems that estimate part machining costs as described above has a configuration in which when an estimate is requested, a part manufacturer (prospective order receiver for part machining), upon reception a CAD file from a client (prospective orderer for the part machining) via a global communication network, calculates an estimated sum by processing the CAD data with a computer, and the calculated estimated sum is sent back automatically to the client via the global communication network (U.S. Pat. No. 6,701,200).

### Second Example of the Related Art

Another known system that estimates part machining costs has a configuration in which a client who is registered in a part cost estimating website in advance based on detailed registration data is connected to the part cost estimating website via internet, and the client receives estimate data or an estimated sum from a part cost estimating server of the part cost estimating website (Japanese Patent No. 4464587).

The first example of the related art, however, has a problem in that the clients need to present the CAD file to the part manufacturer, and thus the clients tend to be reluctant to obtain an estimated sum for machining cost of a confidential developed article from a confidential information leak prevention point of view.

The second example of the related art has a problem in that only users registered to the part cost estimating website in advance on the basis of detailed registration data are allowed to use the system, and thus the clients who want to use the system only with minimum personal information without troublesome user registration cannot use the system at ease. In addition, the second example of the related art has also a problem in that although the system is intended to estimate detailed machining costs relating to parts easily, the clients are required to input a large quantity of data and thus unexperienced technicians cannot use the part cost estimating website at ease.

Accordingly, the invention provides a part machining cost estimating system, a part machining cost estimating method, a part machining cost estimating apparatus, and a part machining cost estimating program which allow clients requesting an estimate to obtain an estimate for part machining costs easily without wondering confidential information leak.

### Means for Solving the Problem

The invention relates to a part machining cost estimating system for estimating machining cost for a part 1.

The part machining cost estimating system includes:

an estimate data input unit 22 that receives an input of estimate data;

an inputted estimate data accepting unit 28 that accepts the inputted estimate data that is inputted via the estimate data input unit 22;

a determination unit 30 that determines whether the inputted estimate data accepted by the inputted estimate data accepting unit 28 satisfies predetermined estimate conditions or not;

an estimate reference price memory unit 13 in which estimate reference prices derived in accordance with first predicted data of the inputted estimate data in advance based on experiences are stored in association with the first predicted data of the inputted estimate data;

an estimate coefficient memory unit 14 in which coefficients that are to be multiplied to the estimate reference prices and are derived in accordance with second predicted data of the inputted estimate data derived in advance based on experiences are stored in association with the second predicted data of the inputted estimate data; and

an estimated sum calculating unit 31 that calculates an estimated sum for machining cost for the part 1 by multiplying the estimate reference price corresponding to the first predicted data which matches the inputted estimate data by the coefficient corresponding to the second predicted data which matches the inputted estimate data.

The inputted estimate data includes at least the maximum width of the part 1, the height of the part 1, and the area ratio (surface area/projected area) of the part 1. The first predicted data is set to correspond to the maximum width of the part 1 in the inputted estimate data. The second predicted data is set to correspond at least to the area ratio (surface area/projected area) of the part 1 in the inputted estimate data.

The invention relates to a part machining cost estimating method for estimating machining cost for a part 1.

The part machining cost estimating method includes:

inputting estimate data;

accepting the inputted estimate data that is inputted in the inputting estimate data;

determining whether the inputted estimate data accepted in the accepting the inputted estimate data satisfies predetermined estimate conditions or not;

storing estimate reference prices derived in accordance with first predicted data of the inputted estimate data in advance based on experiences in an estimate reference price memory unit 13 in association with the first predicted data of the inputted estimate data;

storing coefficients that are to be multiplied to the estimate reference prices and are derived in accordance with second predicted data of the inputted estimate data derived in advance based on experiences in an estimate coefficient memory unit 14 in association with the second predicted data of the inputted estimate data; and

calculating an estimated sum for machining cost for the part by multiplying the estimate reference price corresponding to the first predicted data which matches the inputted estimate data by the coefficient corresponding to the second predicted data which matches the inputted estimate data.

The inputted estimate data includes at least the maximum width of the part 1, the height of the part 1, and the area ratio (surface area/projected area) of the part 1. The first predicted data is set to correspond to the maximum width of the part 1 in the inputted estimate data. The second predicted data is set to correspond at least to the area ratio (surface area/projected area) of the part 1 in the inputted estimate data.

The invention relates to a part machining cost estimating apparatus 6 for estimating machining cost for a part 1.

The part machining cost estimating apparatus 6 includes:

an inputted estimate data accepting unit 28 that accepts inputted estimate data;

a determination unit 30 that determines whether the inputted estimate data accepted by an inputted estimate data accepting unit 28 satisfies predetermined estimate conditions or not;

an estimate reference price memory unit 13 in which estimate reference prices derived in accordance with first predicted data of the inputted estimate data in advance based on experiences are stored in association with the first predicted data of the inputted estimate data;

an estimate coefficient memory unit 14 in which coefficients that are to be multiplied to the estimate reference prices and are derived in accordance with second predicted data of the inputted estimate data derived in advance based on experiences are stored in association with the second predicted data of the inputted estimate data; and

an estimated sum calculating unit 31 that calculates an estimated sum for machining cost for the part 1 by multiplying the estimate reference price corresponding to the first predicted data which matches the inputted estimate data by the coefficient corresponding to the second predicted data which matches the inputted estimate data.

The inputted estimate data includes at least the maximum width of the part 1, the height of the part 1, and the area ratio (surface area/projected area) of the part 1. The first predicted data is set to correspond to the maximum width of the part 1 in the inputted estimate data. The second predicted data is set to correspond at least to the area ratio (surface area/projected area) of the part 1 in the inputted estimate data.

The invention also provides a part machining cost estimating program that causes a computer to function as

an inputted estimate data accepting unit 28 that accepts inputted estimate data;

a determination unit 30 that determines whether inputted estimate data accepted by an inputted estimate data accepting unit 28 satisfies predetermined estimate conditions or not;

an estimate reference price memory unit 13 in which estimate reference prices derived in accordance with first predicted data of the inputted estimate data in advance based on experiences are stored in association with the first predicted data of the inputted estimate data;

an estimate coefficient memory unit 14 in which coefficients that are to be multiplied to the estimate reference prices and are derived in accordance with second predicted data of the inputted estimate data derived in advance based on experiences are stored in association with the second predicted data of the inputted estimate data; and

an estimated sum calculating unit 31 that calculates an estimated sum for machining cost for the part 1 by multiplying the estimate reference price corresponding to the first predicted data which matches the inputted estimate data by the coefficient corresponding to the second predicted data which matches the inputted estimate data.

### Advantageous Effects of Invention

According to the invention, since an estimate based on experiences may be provided with simple and small volume of input data without requiring presentation of a CAD file and without requiring user registration based on detailed registration data at the time of an estimate, a client requesting an estimate is allowed to obtain an estimate for part machining cost at ease without warring about confidential information leak.

### BRIEF DESCRIPTION OF DRAWINGS

FIG. 1 is a drawing illustrating a configuration of a part machining cost estimating system according to an embodiment of the invention;

FIG. 2A is a drawing illustrating an estimate data input window displayed on a display unit of a client visiting a part machining cost estimating server;

FIG. 2B is a drawing illustrating a modification (first estimate data input window) of the estimate data input window in FIG. 2A;

FIG. 2C is a drawing illustrating a modification (second estimate data input window) of the estimate data input window in FIG. 2A;

FIG. 3 is a drawing illustrating an example of displayed numerical values in a pulldown menu regarding the maximum width of a part;

FIG. 4A is a plan view of a part subjected to an estimate for machining cost by the part machining cost estimating system of the embodiment;

FIG. 4B is a side view of the part in FIG. 4A;

FIG. 4C is a cross-sectional view of the part in FIG. 4A taken along the line A1-A1;

FIG. 5A is a drawing of a metal mold for injection molding of a part in a state in which a first metal mold is removed and illustrating a second metal mold in plan view;

FIG. 5B is a vertical cross-sectional view of the metal mold;

FIG. 6 is a flowchart of a machining cost estimating process of the part machining cost estimating system;

FIG. 7 is a functional block diagram of a part machining cost estimating server that constitutes the part machining cost estimating system;

FIG. 8 is a drawing of a display screen indicating a result of estimate;

FIG. 9 is a drawing illustrating a modification of the estimate data input window;

FIG. 10A is a drawing illustrating a modification (first estimate data input window) of the estimate data input window in FIG. 9; and

FIG. 10B is a drawing illustrating a modification (second estimate data input window) of the estimate data input window in FIG. 9.

### DESCRIPTION OF EMBODIMENTS

Embodiments of the invention will be described in detail below with reference to the drawings.

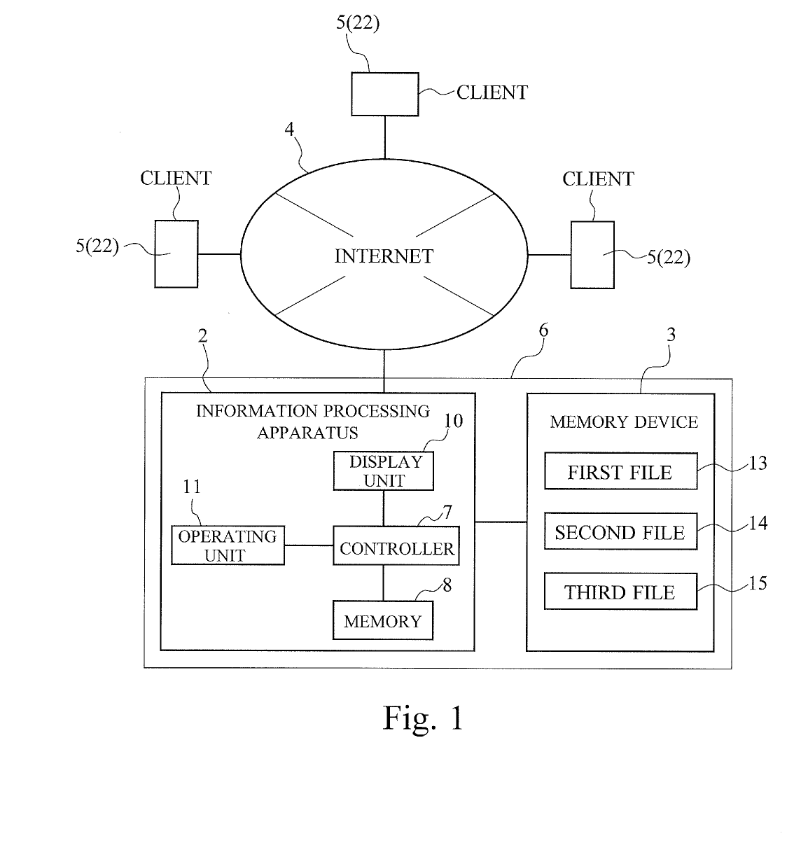

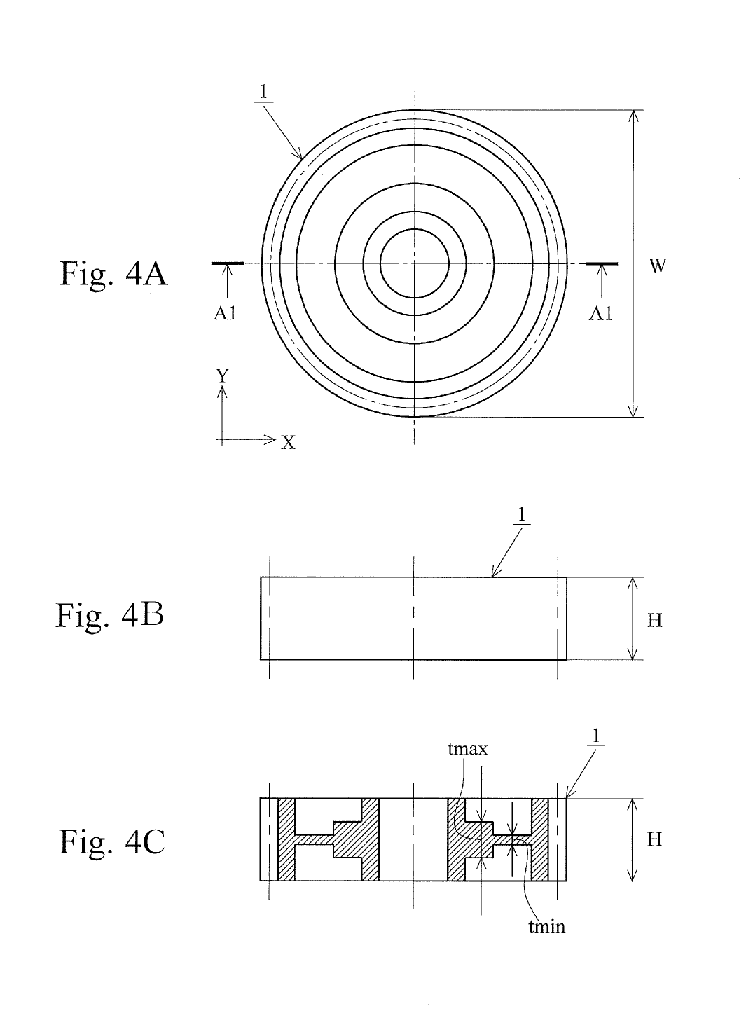

FIG. 1 is a drawing illustrating a configuration of a part machining cost estimating system according to an embodiment of the invention. The part machining cost estimating system illustrated in FIG. 1 is a system for estimating machining cost required for manufacturing a part 1 (for example, a resin gear, a metallic gear as illustrated in FIGS. 4A to 4C), and includes an information processing apparatus 2 and a memory device 3, so that the information processing apparatus 2 is connected to a client 5 (computer, smart phone, etc.) via internet 4. The information processing apparatus 2 and the memory device 3 constitute a part machining cost estimating server (part machining cost estimating apparatus) 6.

The information processing apparatus 2 includes a controller 7, a memory 8, a display unit 10, and an operating unit 11. The memory device 3 is connected to the information processing apparatus 2 either directly or via a network such as LAN, and includes various data required for calculating estimates for part machining costs, estimate data (estimate numbers, inputted estimate data, and estimated sums) or the like stored therein.

The controller 7 of the information processing apparatus 2 is provided with a CPU (central processing unit) or the like, and performs processing such as estimating part machining cost from various data in accordance with a control program (part machining cost estimating program, etc.) stored in the memory 8, displaying an estimated sum on the display unit 10, and transmitting the estimated sum to the client 5 visiting the website via a communicating unit which is not illustrated.

The memory 8 of the information processing apparatus 2 includes a ROM in which the control program for causing the CPU to perform processing is stored, and a RAM that temporarily stores data required for calculating an estimate for part machining cost and secures a working area required by the CPU for processing.

The display unit 10 of the information processing apparatus 2 is composed of a display monitor (for example, a liquid-crystal display panel, and an organic EL panel) or the like, and displays an estimate data input window for inputting data for estimating part machining cost, an estimate result display window for displaying an estimated sum for the part machining cost, and the like.

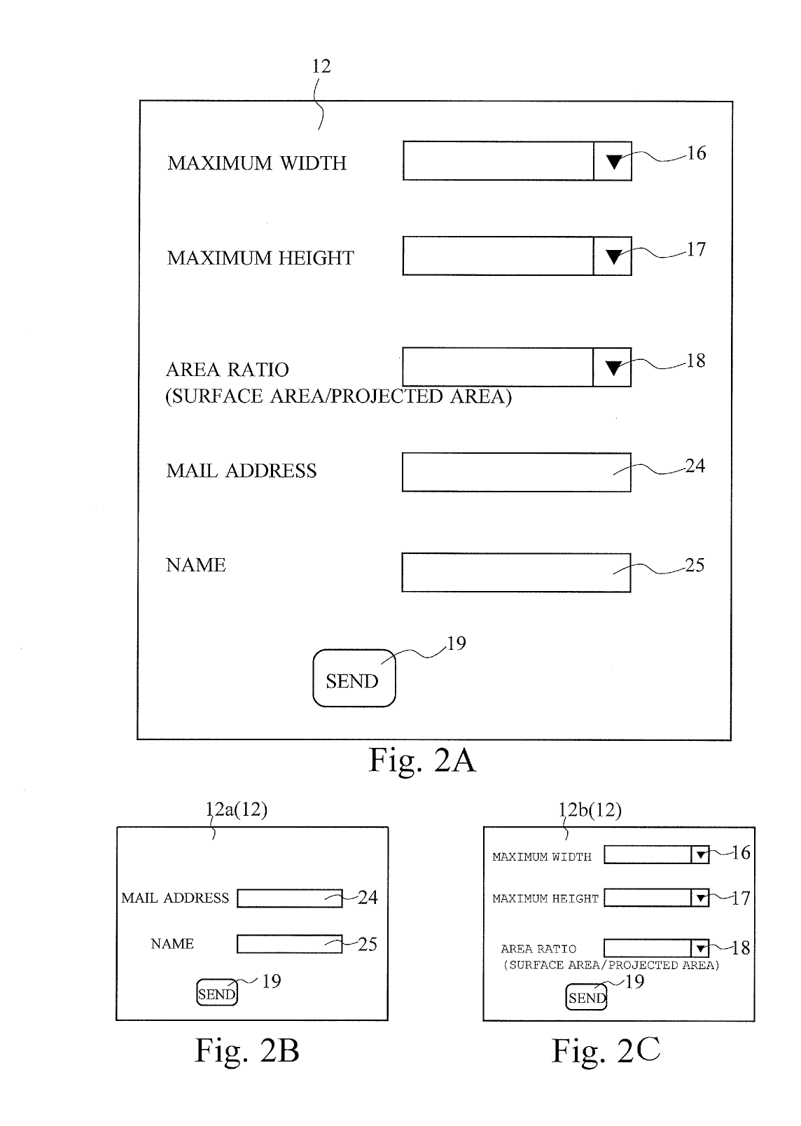

The operating unit 11 of the information processing apparatus 2 includes a keyboard and a mouse, is configured to allow an input of the estimate data for part machining cost via an estimate data input window 12 (see FIG. 2), and functions also as an estimate data input unit. Therefore, the part machining cost estimating system of the embodiment is configured to allow calculation of an estimate for part machining cost even when being disconnected from the internet 4.

The memory device 3 includes a first file (estimate reference price memory unit) 13 that stores an estimate reference price, a second file (estimate coefficient memory unit) 14 that stores coefficients to be multiplied to the estimate reference prices, and a third file (estimate data memory unit) 15 that stores estimated sums in association with estimate numbers together with the inputted estimate data.

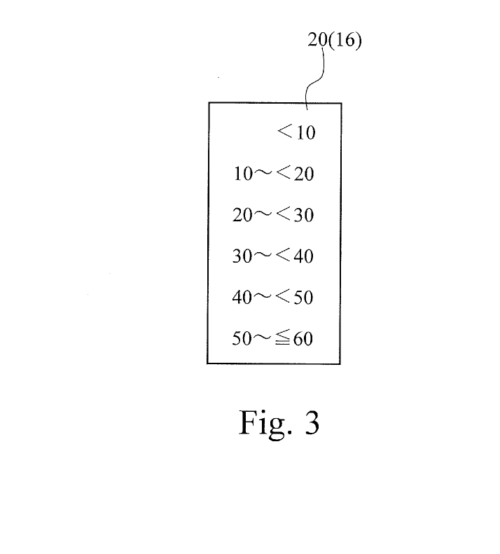

FIG. 2A is a drawing illustrating the estimate data input window 12 displayed on a display unit (screen of a liquid crystal display panel, etc.) of the client 5 visiting the part machining cost estimating server 6. The estimate data input window 12 is configured to allow users to input data by selecting the maximum width of the part 1, the maximum height of the part 1, and the area ratio (surface area/projected area) from displayed numerical values or displayed ranges of numerical values in pulldown menus 16 to 18. FIG. 3 is a drawing illustrating displayed numerical value examples 20 in the pulldown menu 16 regarding the maximum width of the part 1, and the users are allowed to select to input a range of the numerical values of the maximum width of the part 1, to which the part 1 belongs, from the displayed numerical value examples 20. The estimate data input window 12 illustrated in FIG. 2A is configured to allow the users to transmit inputted estimate data to the part machining cost estimating server 6 via the internet 4 by operating (clicking, touching, etc.) a send button 19.

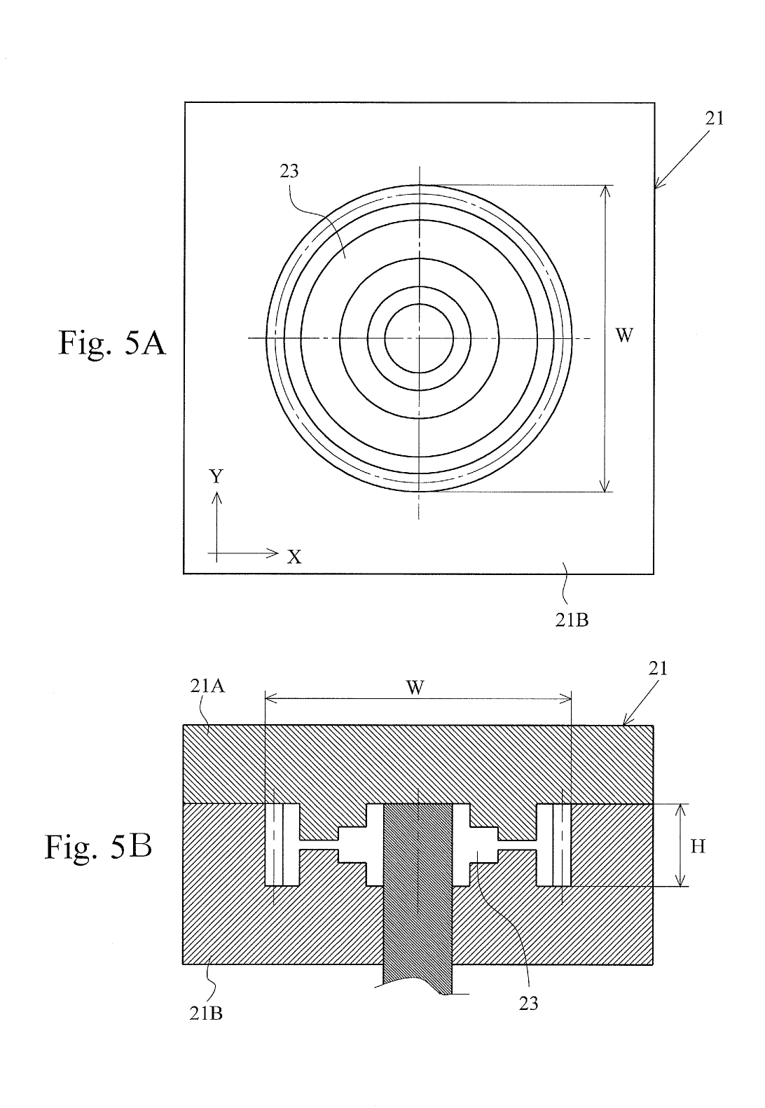

FIG. 4A to FIG. 4C are drawings illustrating the part 1 (for example, a resin gear or a metallic gear) the machining cost of which is estimated by the part machining cost estimating system of the embodiment. FIGS. 5A and 5B are drawings illustrating a metal mold 21 for injection molding the part 1. FIG. 4A is a plan view of the part 1, FIG. 4B is a side view of the part 1, and FIG. 4C is a cross-sectional view of the part 1 taken along the line A1-A1 in FIG. 4A. FIG. 5A is a drawing of the metal mold 21 in which a first metal mold 21A is removed and illustrating a second metal mold 21B in plan view, and FIG. 5B is a vertical cross-sectional view of the metal mold 21.

As illustrated in FIGS. 4A to 4C, the part 1 has the maximum width (the maximum diameter) of W, and the maximum height of H. A projected area of the part 1 corresponds to a surface area of the part 1 projected on an X-Y plane in FIG. 4A (surface area in plan view). A surface area of the part 1 is calculated by a CAD or calculated by an operator on the client 5 side from the engineering design drawing of the part 1. The maximum width (maximum diameter) W of the part 1, the maximum height H of the part 1, and the area ratio (surface area/projected area) of the part 1 are inputted by the estimate data input unit 22 such as a keyboard, a mouse, and a touch panel on the client 5 side as the estimate data via the estimate data input window 12, and the input data is transmitted to the part machining cost estimating server 6 via the internet 4. In the case where the part 1 is a resin gear, the part 1 is injection molded with the metal mold 21 illustrated in FIGS. 5A and 5B. The metal mold 21 has a cavity 23 having the maximum width (the size corresponding to the maximum width of the part 1) of W and the maximum depth (the size corresponding to the maximum height of the part 1) of H, and the surface area of the cavity 23 projected on the X-Y plane in FIG. 5A corresponds to the projected area of the part 1. The machining cost of the part 1 (resin gear) as described above is determined by removal processing (cutting work, grinding work, and the like) of the metal mold 21 unless otherwise a specific resin material is used. In the case where the part 1 is a metallic gear manufactured by cutting a metallic material, machining cost of the part 1 is determined by machining cost of the removal processing. The metal mold and the material of the machined articles as the part manufactured by the removal processing in the invention are not limited to the metallic material described above, and any material which is usable for the removal processing including synthetic resin materials and inorganic materials such as ceramic may be applied.

The estimate data input window 12 is configured to allow the users to input an electronic mail address 24 and a name 25 on the client 5 side. The electronic mail address 24 and the name 25 are requested to be inputted to allow electronic mail communication for a case where the part machining cost estimating server 6 side sends a question regarding the estimate to the client 5 side, or for a case of answering to a question or a requirement from the client 5 side from the part machining cost estimating server 6 side. The estimate data input window 12 may be divided into a first estimate data input window 12a illustrated in FIG. 2B and a second estimate data input window 12b illustrated in FIG. 2C. The first estimate data input window 12a is configured to allow the users to input the electronic mail address 24 and the name 25. The second estimate data input window 12b is configured to allow the users to input data by selecting the maximum width of the part 1, the maximum height of the part 1, and the area ratio (surface area/projected area) from displayed numerical values or displayed ranges of numerical values in the pulldown menus 16 to 18. The estimate data input window 12 may be configured to transmit the inputted estimate data from the client 5 side to the part machining cost estimating server 6 side in order of the first estimate data input window 12a and the second estimate data input window 12b.

The first file (estimate reference price memory unit) 13 in the memory device 3 illustrated in FIG. 1 includes estimate reference prices derived based on experiences of technicians who have been in charge of an estimate work for a long time. The estimate reference prices are set in accordance with the displayed numerical value examples 20 (first predicted data) in the pulldown menu 16 provided in the estimate data input window 12 for inputting the maximum width of the part 1 in the inputted estimate data and are stored therein in association with the displayed numerical value examples 20 of the pulldown menu 16. One of the estimate reference prices in the first file 13 is read out in accordance with the maximum width of the part 1 of the inputted estimate data, and is used for calculating the estimated sum of the part machining cost.

The second file (estimate coefficient memory unit) 14 in the memory device 3 illustrated in FIG. 1 includes coefficients derived based on experiences of technicians who have been in charge of an estimate work for a long time. The coefficients are set in accordance with the displayed numerical value examples (second predicted data) in the pulldown menu 17 provided in the estimate data input window 12 for inputting the area ratio (surface area/projected area) in the inputted estimate data, and are stored therein in association with the example of displayed numerical values of the pulldown menu 17. One of the coefficients in the second file 14 is read out in accordance with the area ratio (surface area/projected area) of the inputted estimate data, and is used for calculating the estimated sum of the part machining cost (multiplied to the estimate reference price). Here, the area ratio (surface area/projected area) which serves as basic data when setting a coefficient is a numerical value from which an amount of machining (machining time) and difficulty of the machining in cutting work or the like can be supposed. Therefore, the part machining cost estimating system of the embodiment is capable of providing the client 5 with a result of estimate with accuracy equivalent to the first related art in which an estimated sum is calculated based on CAD data only by multiplying the estimate reference price by a coefficient derived by technicians who have been in charge of estimating work for a long time based on their experiences. The part machining cost estimating system of the embodiment provides an accurate result of estimate to the client 5 only by multiplying the estimate reference price by the coefficient derived by technicians who have been in charge of estimating work for a long time based on their experiences, and thus input of large quantity of estimate data as in the second related art is not necessary, so that labors on a client requesting an estimate (the client 5 side) is alleviated and unexperienced technicians can use the system with ease.

The third file (estimate data memory unit) 15 in the memory device 3 illustrated in FIG. 1 stores estimated sums calculated by the controller 7 (estimated sum calculating unit) of the information processing apparatus 2 together with the inputted estimate data in association with estimate numbers.

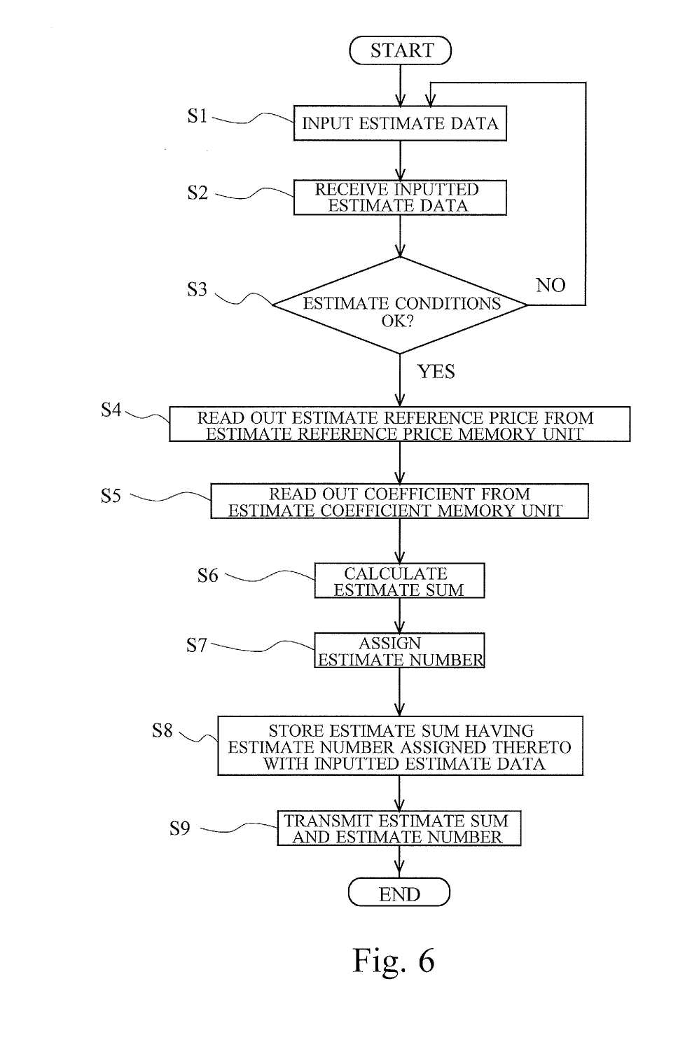

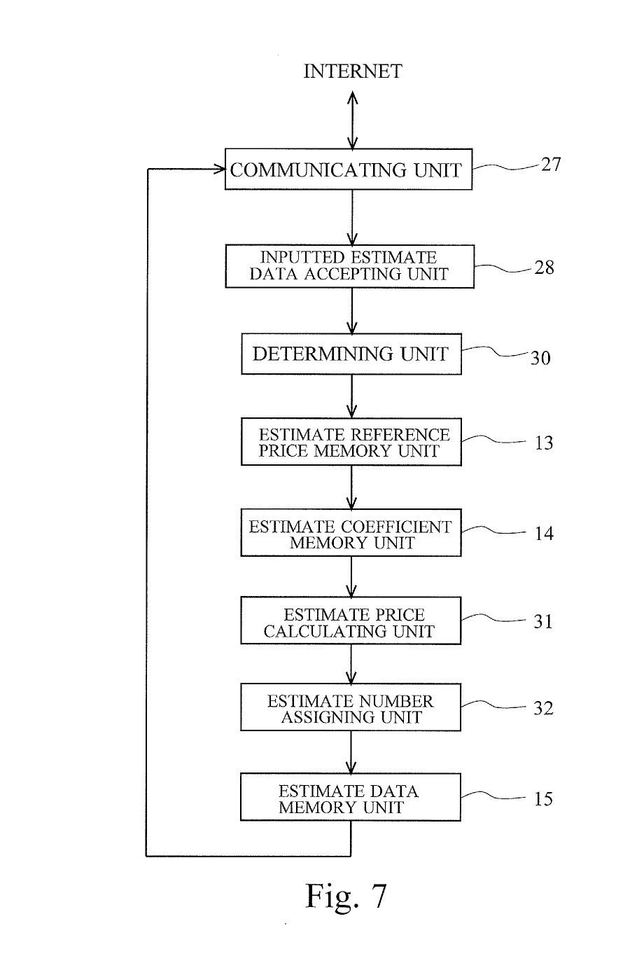

Subsequently, a machining cost estimating process of the part machining cost estimating system will be descried with reference to FIG. 6 and FIG. 7. FIG. 6 is a flowchart of a machining cost estimating process of the part machining cost estimating system. FIG. 7 is a functional block diagram of the part machining cost estimating server 6 that constitutes the part machining cost estimating system.

First of all, the client 5 accesses the part machining cost estimating server 6 via the internet 4, the estimate data input window 12 is displayed on the client 5 side, and estimate data is inputted from the client 5 (estimate data input unit such as personal computer and smart phone) side via the estimate data input window 12 (Step S1).

The inputted estimate data inputted on the client 5 side is transmitted to the part machining cost estimating server 6 via the internet 4, and when the inputted estimate data is received via a communicating unit 27 of the part machining cost estimating server 6, the inputted estimate data is stored temporarily in an estimate input data accepting unit (memory) 28 (Step S2).

Subsequently, as a result of determination of whether the received inputted estimate data satisfies predetermined estimate conditions or not by a determination unit 30, if the inputted estimate data is determined not to satisfy the estimate conditions, the client 5 side is prompted to re-input the inputted estimate data (Step S3).

When the determination unit 30 determines that the received inputted estimate data satisfies the predetermined estimate conditions (Step S3), an estimate reference price corresponding to the first predicted data which matches the maximum width of the inputted estimate data is read out from the estimate reference price memory unit 13 (Step S4).

Subsequently, a coefficient corresponding to the second predicted data which matches the area ratio (surface area/projected area) of the inputted estimate data is read out form the estimate coefficient memory unit 14 (Step S5).

Then, an estimated sum calculating unit 31 calculates an estimated sum by multiplying the estimate reference price read out from the estimate reference price memory unit 13 by the coefficient read out from the estimate coefficient memory unit 14 (Step S6).

Subsequently, an estimate number is assigned to the estimated sum calculated by the estimated sum calculating unit 31 by an estimate number assigning unit 32 (Step S7).

Subsequently, the estimated sum having the estimate number assigned thereto by the estimate number assigning unit 32 is stored to the third file (estimate data memory unit) 15 in the memory device 3 together with the inputted estimate data (Step S8).

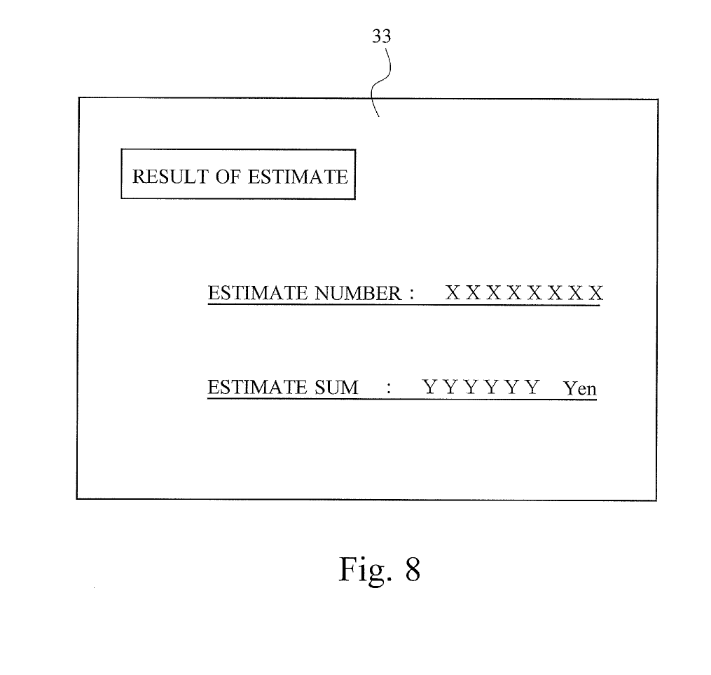

The estimated sum having the estimate number assigned thereto by the estimate number assigning unit 32 is transmitted together with the estimate number to the client 5 that has visited to the corresponding website with the communicating unit 27 via the internet 4 (Step S9). The estimated sum and the estimate number transmitted to the client 5 is displayed on a display screen 33 on the client 5 side as illustrated in FIG. 8.

As described thus far, according to the embodiment, since an estimate based on experiences may be provided with simple and small volume of input data without requiring presentation of a CAD file and without requiring user registration based on detailed registration data at the time of an estimate, a client requesting an estimate (client 5) is allowed to obtain an estimate for part machining cost at ease without warring about confidential information leak.

### Modification

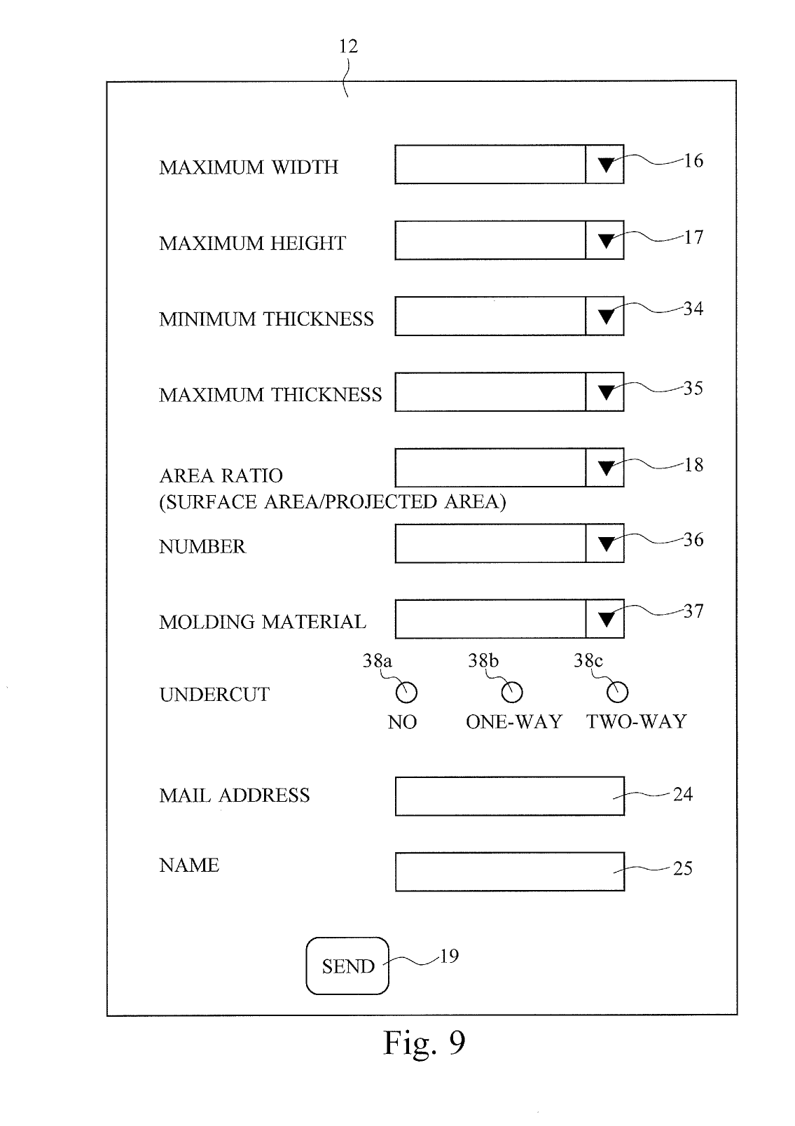

FIG. 9 is a drawing illustrating a modification of the estimate data input window 12 of the embodiment. The estimate data input window 12 of the modification is added with a pulldown menu 34 for inputting the minimum thickness (tmin) of the part 1, a pulldown menu 35 for inputting the maximum thickness (tmax) of the part 1, a pulldown menu 36 for inputting the number of machining processes of the part 1, and a pulldown menu 37 for inputting a molding material of the part 1. The estimate data input window 12 of the modification relates to undercut and is provided with radio buttons 38a to 38c for selecting one of no undercut, one-way undercut, and two-way undercut.

In the modification, the example of displayed numerical values in the pulldown menu 18 regarding the area ratio (surface area/projected area) of the part 1, the example of display of the pulldown menu 37 regarding the molding material of the part 1, and each of the radio buttons 38a to 38c regarding the undercut constitutes the second predicted data and coefficients derived based on experiences of technicians who have been in charge of the estimating work for a long time are set for the respective second predicted data. In the second file (estimate coefficient memory unit) 14 in the memory device 3 includes the coefficients stored in association with the displayed numerical value examples of the pulldown menus 18 and 37 and the radio buttons 38a to 38c. One of the coefficients in the second file 14 is read out in accordance with the area ratio (surface area/projected area), the molding material, and the undercut of the inputted estimate data, and is used for calculating the estimated sum of the part machining cost (multiplied to the estimate reference price).

The part machining cost estimating system in which the estimate data input window 12 of the modification is used requires more estimate input data than the part machining cost estimating system of the embodiment described above. However, since the estimate input data may be easily inputted by using the pulldown menus 16, 17, 34, 35, 18, 36, and 37 or the radio buttons 38a to 38c, the equivalent effects as the part machining cost estimating system of the embodiment described above are achieved as a matter of course, and in addition, accuracy of calculation of the estimated sum may be improved.

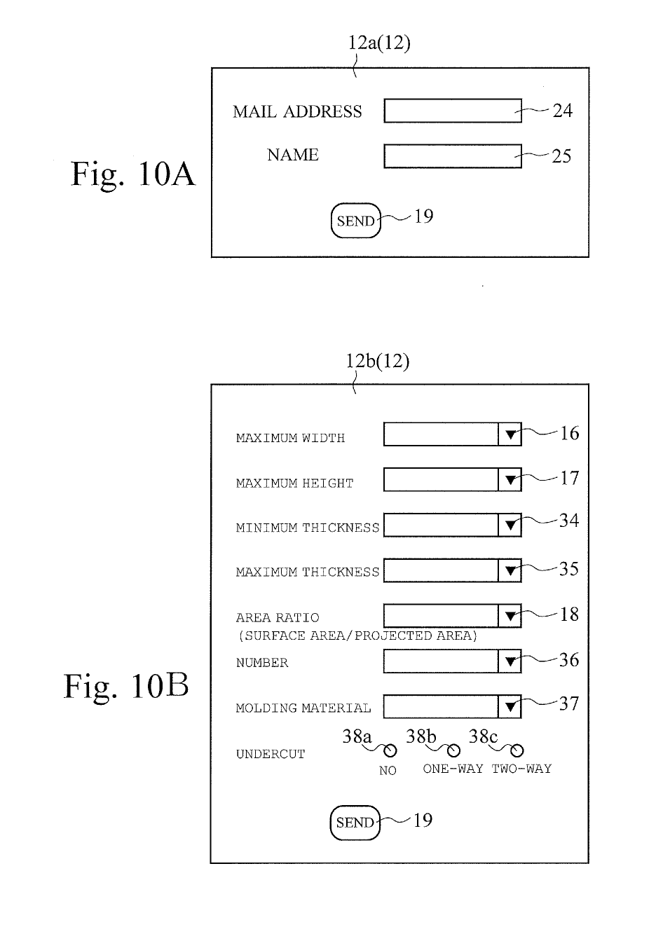

The estimate data input window 12 illustrated in FIG. 9 may be divided into the first estimate data input window 12a illustrated in FIG. 10A and the second estimate data input window 12b illustrated in FIG. 10B. The first estimate data input window 12a is configured to allow the users to input the electronic mail address 24 and the name 25. The second estimate data input window 12b is configured to allow the users to input data by selecting the maximum width of the part 1, the maximum height of the part 1, the minimum thickness (tmin) of the part 1, the maximum thickness (tmax) of the part 1, the area ratio (surface area/projected area), the quantity, and the molding material from the displayed numerical values or the displayed ranges of numerical values in the respective pulldown menus 16, 17, 34, 35, 18, 36, and 37. The second estimate data input window 12b is configured to allow the users to input data by selecting one of no undercut, one-way undercut, and two-way undercut from the radio buttons 38a to 38c. The estimate data input window 12 may be configured to transmit inputted estimate data from the client 5 side to the part machining cost estimating server 6 side in order of the first estimate data input window 12a and the second estimate data input window 12b.

The estimate data input window 12 of the embodiment described above and the modification described above may be modified from the pulldown menus to radio buttons as needed, or may be modified to input numerical values directly by ten keys. The radio buttons may be modified to the pulldown menus. The estimate data input window 12 may be modified in layout of the pulldown menu 16 for the maximum width, the pulldown menu 17 for the maximum height as needed. The estimate data input window 12 may be modified by combining the pulldown menus 34 and 35 for the minimum thickness and the maximum thickness to employ the ranges of the thickness between the minimum thickness and the maximum thickness as the examples of displayed numerical values in the pulldown menus, or may be configured to input the range of the thickness between the minimum thickness and the maximum thickness by selecting one of the radio buttons.

The resin gear and the metallic gear have been described as the part 1 in the embodiment described above and the example described above. The invention, however, is not limited thereto, and may be applied widely to machining cost estimates for the various parts 1 (such as parts of precision fluid instrument, optical parts, and various automotive vehicle parts).

1. A part machining cost estimating system for estimating machining cost for a part, comprising:
an estimate data input unit that receives an input of estimate data;
an inputted estimate data accepting unit that accepts the inputted estimate data that is inputted via the estimate data input unit;
a determination unit that determines whether the inputted estimate data accepted by the inputted estimate data accepting unit satisfies predetermined estimate conditions or not;
an estimate reference price memory unit in which estimate reference prices derived in accordance with first predicted data of the inputted estimate data in advance based on experiences are stored in association with the first predicted data of the inputted estimate data;
an estimate coefficient memory unit in which coefficients that are to be multiplied to the estimate reference prices and are derived in accordance with second predicted data of the inputted estimate data derived in advance based on experiences are stored in association with the second predicted data of the inputted estimate data; and
an estimated sum calculating unit that calculates an estimated sum for machining cost for the part by multiplying the estimate reference price corresponding to the first predicted data which matches the inputted estimate data by the coefficient corresponding to the second predicted data which matches the inputted estimate data,
wherein the inputted estimate data includes at least the maximum width of the part, the height of the part, and the area ratio (surface area/projected area) of the part,
the first predicted data is set to correspond to the maximum width of the part in the inputted estimate data, and
the second predicted data is set to correspond at least to the area ratio (surface area/projected area) of the part in the inputted estimate data.

2. A part machining cost estimating system for estimating machining cost for a part, comprising:
an estimate data input unit that receives an input of estimate data;
an inputted estimate data accepting unit that accepts the inputted estimate data that is inputted via the estimate data input unit;
a determination unit that determines whether the inputted estimate data accepted by the inputted estimate data accepting unit satisfies predetermined estimate conditions or not;
an estimate reference price memory unit in which estimate reference prices derived in accordance with first predicted data of the inputted estimate data in advance based on experiences are stored in association with the first predicted data of the inputted estimate data;
an estimate coefficient memory unit in which coefficients that are to be multiplied to the estimate reference prices and are derived in accordance with second predicted data of the inputted estimate data derived in advance based on experiences are stored in association with the second predicted data of the inputted estimate data; and
an estimated sum calculating unit that calculates an estimated sum by multiplying the estimate reference price corresponding to the first predicted data which matches the inputted estimate data by the coefficient corresponding to the second predicted data which matches the inputted estimate data,
wherein the inputted estimate data includes at least the maximum width of the part, a height of the part, the minimum thickness of the part, the maximum thickness of the part, an area ratio (surface area/projected area) of the part, a quantity of the part, a molding material of the part, and presence or absence and the number of directions of undercut on the part,
the first predicted data is set to correspond to the maximum width of the part in the inputted estimate data, and
the second predicted data is set to correspond at least to the area ratio (surface area/projected area) of the part, the molding material of the part, and presence or absence and the number of directions of undercut on the part in the inputted estimate data.

3. The part machining cost estimating system according to claim 1 or 2, wherein the part machining cost estimating system includes a communicating unit that accepts an access from an external terminal via a network, and transmits the estimated sum to the external terminal together with the estimate number.

4. A part machining cost estimating method for estimating machining cost for a part, comprising:
inputting estimate data;
accepting the inputted estimate data that is inputted in the inputting estimate data;
determining whether the inputted estimate data accepted in the accepting the inputted estimate data satisfies predetermined estimate conditions or not;
storing estimate reference prices derived in accordance with first predicted data of the inputted estimate data in advance based on experiences in an estimate reference price memory unit in association with the first predicted data of the inputted estimate data;
storing coefficients that are to be multiplied to the estimate reference prices and are derived in accordance with second predicted data of the inputted estimate data derived in advance based on experiences in an estimate coefficient memory unit in association with the second predicted data of the inputted estimate data; and
calculating an estimated sum for machining cost for the part by multiplying the estimate reference price corresponding to the first predicted data which matches the inputted estimate data by the coefficient corresponding to the second predicted data which matches the inputted estimate data,
wherein the inputted estimate data includes at least the maximum width of the part, the height of the part, and the area ratio (surface area/projected area) of the part,
the first predicted data is set to correspond to the maximum width of the part in the inputted estimate data, and
the second predicted data is set to correspond at least to the area ratio (surface area/projected area) of the part in the inputted estimate data.

5. A part machining cost estimating method for estimating machining cost for a part, comprising:
inputting estimate data;
accepting the inputted estimate data that is inputted in the inputting estimate data;
determining whether the inputted estimate data accepted in the accepting the inputted estimate data satisfies predetermined estimate conditions or not;
storing estimate reference prices derived in accordance with first predicted data of the inputted estimate data in advance based on experiences in an estimate reference price memory unit in association with the first predicted data of the inputted estimate data;
storing coefficients that are to be multiplied to the estimate reference prices and are derived in accordance with second predicted data of the inputted estimate data derived in advance based on experiences in an estimate coefficient memory unit in association with the second predicted data of the inputted estimate data; and
calculating an estimated sum for machining cost for the part by multiplying the estimate reference price corresponding to the first predicted data which matches the inputted estimate data by the coefficient corresponding to the second predicted data which matches the inputted estimate data,
wherein the inputted estimate data includes at least the maximum width of the part, a height of the part, the minimum thickness of the part, the maximum thickness of the part, an area ratio (surface area/projected area) of the part, a quantity of the part, a molding material of the part, and presence or absence and the number of directions of undercut on the part,
the first predicted data is set to correspond to the maximum width of the part in the inputted estimate data, and
the second predicted data is set to correspond at least to the area ratio (surface area/projected area) of the part, the molding material of the part, and presence or absence and the number of directions of undercut on the part in the inputted estimate data.

6. The part machining cost estimating method according to claim 4 or 5, wherein the part machining cost estimating method accepts an access from an external terminal via a network, and transmits the estimated sum to the external terminal together with the estimate number.

7. A part machining cost estimating apparatus for estimating machining cost for a part, comprising:
an inputted estimate data accepting unit that accepts inputted estimate data;
a determination unit that determines whether inputted estimate data accepted by the inputted estimate data accepting unit satisfies predetermined estimate conditions or not;
an estimate reference price memory unit in which estimate reference prices derived in accordance with first predicted data of the inputted estimate data in advance based on experiences are stored in association with the first predicted data of the inputted estimate data;
an estimate coefficient memory unit in which coefficients that are to be multiplied to the estimate reference prices and are derived in accordance with second predicted data of the inputted estimate data derived in advance based on experiences are stored in association with the second predicted data of the inputted estimate data; and
an estimated sum calculating unit that calculates an estimated sum for machining cost for the part by multiplying the estimate reference price corresponding to the first predicted data which matches the inputted estimate data by the coefficient corresponding to the second predicted data which matches the inputted estimate data,
wherein the inputted estimate data includes at least the maximum width of the part, the height of the part, and the area ratio (surface area/projected area) of the part,
the first predicted data is set to correspond to the maximum width of the part in the inputted estimate data, and
the second predicted data is set to correspond at least to the area ratio (surface area/projected area) of the part in the inputted estimate data.

8. A part machining cost estimating apparatus for estimating machining cost for a part, comprising:
an inputted estimate data accepting unit that accepts inputted estimate data;
a determination unit that determines whether inputted estimate data accepted by an inputted estimate data accepting unit satisfies predetermined estimate conditions or not;
an estimate reference price memory unit in which estimate reference prices derived in accordance with first predicted data of the inputted estimate data in advance based on experiences are stored in association with the first predicted data of the inputted estimate data;
an estimate coefficient memory unit in which coefficients that are to be multiplied to the estimate reference prices and are derived in accordance with second predicted data of the inputted estimate data derived in advance based on experiences are stored in association with the second predicted data of the inputted estimate data; and
an estimated sum calculating unit that calculates an estimated sum by multiplying the estimate reference price corresponding to the first predicted data which matches the inputted estimate data by the coefficient corresponding to the second predicted data which matches the inputted estimate data,
wherein the inputted estimate data includes at least the maximum width of the part, a height of the part, the minimum thickness of the part, the maximum thickness of the part, an area ratio (surface area/projected area) of the part, a quantity of the part, a molding material of the part, and presence or absence and the number of directions of undercut on the part,
the first predicted data is set to correspond to the maximum width of the part in the inputted estimate data, and
the second predicted data is set to correspond at least to the area ratio (surface area/projected area) of the part, the molding material of the part, and presence or absence and the number of directions of undercut on the part in the inputted estimate data.

9. The part machining cost estimating apparatus according to claim 7, wherein the part machining cost estimating apparatus includes a communicating unit that accepts an access from an external terminal via a network, and transmits the estimated sum to the external terminal together with the estimate number.

10. A part machining cost estimating program to be implemented by a computer, the computer comprising:
an inputted estimate data accepting unit that accepts inputted estimate data;
a determination unit that determines whether inputted estimate data accepted by the inputted estimate data accepting unit satisfies predetermined estimate conditions or not;
an estimate reference price memory unit in which estimate reference prices derived in accordance with first predicted data of the inputted estimate data in advance based on experiences are stored in association with the first predicted data of the inputted estimate data;
an estimate coefficient memory unit in which coefficients that are to be multiplied to the estimate reference prices and are derived in accordance with second predicted data of the inputted estimate data derived in advance based on experiences are stored in association with the second predicted data of the inputted estimate data; and
an estimated sum calculating unit that calculates an estimated sum for machining cost for the part by multiplying the estimate reference price corresponding to the first predicted data which matches the inputted estimate data by the coefficient corresponding to the second predicted data which matches the inputted estimate data.

11. The part machining cost estimating system according to claim 2, wherein the part machining cost estimating system includes a communicating unit that accepts an access from an external terminal via a network, and transmits the estimated sum to the external terminal together with the estimate number.

12. The part machining cost estimating method according to claim 5, wherein the part machining cost estimating method accepts an access from an external terminal via a network, and transmits the estimated sum to the external terminal together with the estimate number.

13. The part machining cost estimating apparatus according to claim 8, wherein the part machining cost estimating apparatus includes a communicating unit that accepts an access from an external terminal via a network, and transmits the estimated sum to the external terminal together with the estimate number.
